(19) United States
(12) Patent Application Publication
(10) Pub. No.: US 2026/0322691 A1
(43) Pub. Date: Oct. 15, 2026

(54) METHOD AND SERVER FOR SERVICE PARAMETER PROVISIONING

(71) Applicant: Samsung Electronics Co., Ltd., Suwon-si, Gyeonggi-do (KR)

(72) Inventors: Narendranath Durga TANGUDU, Bangalore (IN); Sapan Pramodkumar SHAH, Bangalore (IN); Basavaraj Jayawant PATTAN, Bangalore (IN)

(21) Appl. No.: 19/483,582

(22) PCT Filed: May 10, 2024
(86) PCT No.: PCT/KR2024/006325

§ 371 Date: Nov. 11, 2025

(30) Foreign Application Priority Data
May 12, 2023 (IN) 202341033737
Apr. 25, 2024 (IN) 202341033737

(51) Int. Cl. H04L 41/0853; H04L 41/08; H04L 67/00; H04W 4/50; H04W 80/12

(52) U.S. Cl. CPC H04L 41/0853; H04L 41/0886; H04L 67/34; H04W 4/50; H04W 80/12

(57) ABSTRACT

The disclosure relates to a 5G or 6G communication system for supporting a higher data transmission rate. The present disclosure describes a method (300a. 300b and 300c) and a Service Enabler Architecture Layer (SEAL) server (103) for service parameter provisioning. The method (300a) comprises receiving (301a) a fetch configuration request for fetching a VAL service specific configuration information provisioned at the SEAL server (103); and sending (303a) a fetch configuration response. The method (300b) comprises receiving (301b) an update configuration request for updating (303b) VAL service specific configuration information provisioned at the SEAL server (103) for a set of VAL services; updating (303b) the VAL service specific configuration information as received in the update configuration request; and sending (305b) an update configuration response. The method (300c) comprises receiving (301c) delete configuration request for deleting VAL service specific configuration information provisioned at the SEAL server (103); deleting (303c) the VAL service specific configuration information as in the delete configuration request; and sending (305c) a delete configuration response.

### TECHNICAL FIELD

The present disclosure relates to wireless communication. Particularly, but not exclusively, the present disclosure relates to a method and a server for service parameter provisioning.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

3GPP exposes the network and application enabler layer services for consumption by third party Application Functions (AF) through northbound APIs. 3GPP specified Service Enabler Architecture Layer for Verticals (SEAL) in TS 23.434, defining a set of common services (e.g. group management, configuration management, location management) that can be shared across multiple vertical applications. To ensure efficient use and deployment of vertical applications over 3GPP systems, SEAL common services include group management, configuration management, location management, identity management, key management, network resource management, notification management, network slice capability enablement, data delivery and application data analytics enablement.

In Rel-18 of 3GPP specified (clause 12.3.4, 3GPP TS 23.434) a procedure for a VAL server to provision the required VAL service specific configuration information to the SEAL identity management server to support VAL user authentication. This information includes the VAL service Identifier (ID) (s) and the corresponding VAL users (VAL UE IDs or VAL User IDs) for each of the VAL service. SEAL SS_IdmParameterProvisioning API (as specified in clause 12.4.3., 3GPP TS 23.434) is the northbound API from SEAL Identity Management server, that the VAL server consumes to provision the configuration information for the VAL service.

In the current state of the art, it is possible that a single VAL service provider may have multiple VAL servers that may need to interact with the SEAL server (Identity Management server) to provision the configuration information (VAL users information) specific to a given VAL service. The VAL services offered may be from multiple VAL servers which may belong to same VAL system or different partner VAL systems. Hence, it is possible that the VAL service specific configuration information will be common across these multiple VAL servers. So, when one VAL server provisions the configuration (VAL users information) specific to given VAL services, then there is no mechanism for this or another VAL server to fetch the configuration information (VAL users information) provisioned at SEAL Identity Management server for a given VAL service and further, no mechanism for this or another VAL server to update the existing VAL service specific configuration (VAL users information) information at the SEAL Identity Management Server. Also, there is no mechanism specified for the VAL server to de-provision/remove the configuration (VAL users information) provisioned at the SEAL Identity Management server.

The above stated shortcomings, lead to inability for the VAL server to fetch, update and remove/de-provision the VAL service specific configuration (VAL user information) information and hence possible presence of old/stale VAL user information for the VAL services at SEAL Identity Management server. This will further lead to potential problems like non-availability of the VAL services to VAL users, security risks of exposing the VAL services to unauthorized VAL users, etc.

Thus, it is desired to address the above-mentioned disadvantages or other shortcomings and at least provide a useful alternative.

The above mentioned problem statement and solution alternatives illustrated in present disclosure, apply to any configuration information of a VAL service, apart from the currently 3GPP specified VAL users information as part of VAL service configuration information.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE OF INVENTION

### Solution to Problem

The present disclosure tries to address the aforesaid problem associated with fetching, updating and deleting the VAL service-specific configuration information (VAL users information) at the SEAL Identity Management server.

In an embodiment, the present disclosure relates to a method for service parameter provisioning. The method comprising receiving, a fetch configuration request for fetching a VAL service specific configuration information provisioned at the SEAL server. Subsequently, the method comprises sending, a fetch configuration response.

In an embodiment, the present disclosure relates to a method for service parameter provisioning. The method comprising receiving an update configuration request for updating a VAL service specific configuration information provisioned at the SEAL server for a set of VAL services. Subsequently, the method comprises updating the VAL service specific configuration information as received in the update configuration request. Lastly, the method comprises sending an update configuration response.

In an embodiment, the present disclosure relates to a method for service parameter provisioning. The method comprising receiving a delete configuration request for deleting a VAL service specific configuration information provisioned at the SEAL server. Subsequently, the method comprises deleting the VAL service specific configuration information as in the delete configuration request. Lastly, the method comprises sending a delete configuration response.

In another embodiment, the present disclosure relates to a Service Enabler Architecture Layer (SEAL) server for service parameter provisioning. The SEAL server comprising a processor and a memory. The memory stores processor-executable instructions, which, on execution, cause the processor to receive a fetch configuration request for fetching a VAL service specific configuration information provisioned at the SEAL server. Subsequently, the processor is configured to send a fetch configuration response.

In another embodiment, the present disclosure relates to a Service Enabler Architecture Layer (SEAL) server for service parameter provisioning. The SEAL server comprising a processor and a memory. The memory stores processor-executable instructions, which, on execution, cause the processor to receive an update configuration request for updating a VAL service specific configuration information provisioned at the SEAL server for a set of VAL services. Subsequently, the processor is configured to update the VAL service specific configuration information at the SEAL server, as received in the update configuration request. Lastly, the processor is configured to send an update configuration response.

In another embodiment, the present disclosure relates to a Service Enabler Architecture Layer (SEAL) server for service parameter provisioning. The SEAL server comprising a processor and a memory. The memory stores processor-executable instructions, which, on execution, cause the processor to receive a delete configuration request for deleting a VAL service specific configuration information provisioned at the SEAL server. Subsequently, the processor is configured to delete the VAL service specific configuration information as in the delete configuration request. Lastly, the processor is configured to send a delete configuration response.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and methods in accordance with embodiments of the present subject matter are now described below, by way of example only, and with reference to the accompanying figures.

FIGS. 1a, 1b, and 1c illustrate a sequence diagram for service parameter provisioning in accordance with some embodiments of the present disclosure.

FIG. 2 shows a detailed block diagram of a SEAL server in accordance with some embodiments of the present disclosure.

FIGS. 3a, 3b, and 3c show flowcharts illustrating a method for service parameter provisioning in accordance with some embodiments of the present disclosure.

FIG. 4 is a block diagram of an exemplary system for implementing embodiments consistent with the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### MODE FOR THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

### OVERVIEW

GPP exposes the network and application enabler layer services for consumption by third party Application Functions (AF) through northbound APIs. 3GPP specified Service Enabler Architecture Layer for Verticals (SEAL) in TS 23.434, defining a set of common services (e.g. group management, configuration management, location management) that can be shared across multiple vertical applications. To ensure efficient use and deployment of vertical applications over 3GPP systems, SEAL common services include group management, configuration management, location management, identity management, key management, network resource management, notification management, network slice capability enablement, data delivery and application data analytics enablement.

In Rel-18 of 3GPP specified (clause 12.3.4, 3GPP TS 23.434) a procedure for a VAL server to provision the required VAL service specific configuration information to the SEAL identity management server to support VAL user authentication. This information includes the VAL service Identifier (ID) (s) and the corresponding VAL users (VAL UE IDs or VAL User IDs) for each of the VAL service. SEAL SS_IdmParameterProvisioning API (as specified in clause 12.4.3., 3GPP TS 23.434) is the northbound API from SEAL Identity Management server, that the VAL server consumes to provision the configuration information for the VAL service.

In the current state of the art, it is possible that a single VAL service provider may have multiple VAL servers that may need to interact with the SEAL server (Identity Management server) to provision the configuration information (VAL users information) specific to a given VAL service. The VAL services offered may be from multiple VAL servers which may belong to same VAL system or different partner VAL systems. Hence, it is possible that the VAL service specific configuration information will be common across these multiple VAL servers. So, when one VAL server provisions the configuration (VAL users information) specific to given VAL services, then there is no mechanism for this or another VAL server to fetch the configuration information (VAL users information) provisioned at SEAL Identity Management server for a given VAL service and further, no mechanism for this or another VAL server to update the existing VAL service specific configuration (VAL users information) information at the SEAL Identity Management Server and there is no mechanism specified for the VAL server to de-provision/remove the configuration (VAL users information) provisioned at the SEAL Identity Management server.

The above stated shortcomings, lead to inability for the VAL server to fetch, update and remove/de-provision the VAL service specific configuration (VAL user information) information and hence possible presence of old/stale VAL user information for the VAL services at SEAL Identity Management server. This will further lead to potential problems like non-availability of the VAL services to VAL users, security risks of exposing the VAL services to unauthorized VAL users, etc.

Thus, it is desired to address the above-mentioned disadvantages or other shortcomings and at least provide a useful alternative.

The above problem statement and solution alternatives illustrated in this invention, apply to any configuration information of a VAL service, apart from the currently 3GPP specified VAL users information as part of VAL service configuration information.

On the basis of the limitations of the prior works, the current description addresses the explained problem of updating the VAL service-specific configuration information (VAL users information) at the SEAL Identity Management server.

Described in detail in the forthcoming paragraphs is a method for a VAL server to fetch, update and delete the VAL service-specific configuration information provisioned at SEAL server, wherein the requesting VAL server may be different from the VAL server that initially provisioned the VAL service specific configuration information at the SEAL server.

The solutions proposed by the current description can be described briefly as:
(a) VAL server fetches the VAL service-specific configuration information provisioned at SEAL server.
(b) VAL server updates the VAL service-specific configuration information provisioned at SEAL server.
(c) VAL server removes/de-provisions the VAL service-specific configuration information provisioned at the SEAL server.

The accompanying drawings, which are incorporated in and constitute a part of this disclosure, illustrate exemplary embodiments and, together with the description, serve to explain the disclosed principles. Some embodiments of system and/or methods in accordance with embodiments of the present subject matter are now described, by way of example only, and regarding the accompanying figures, in which:

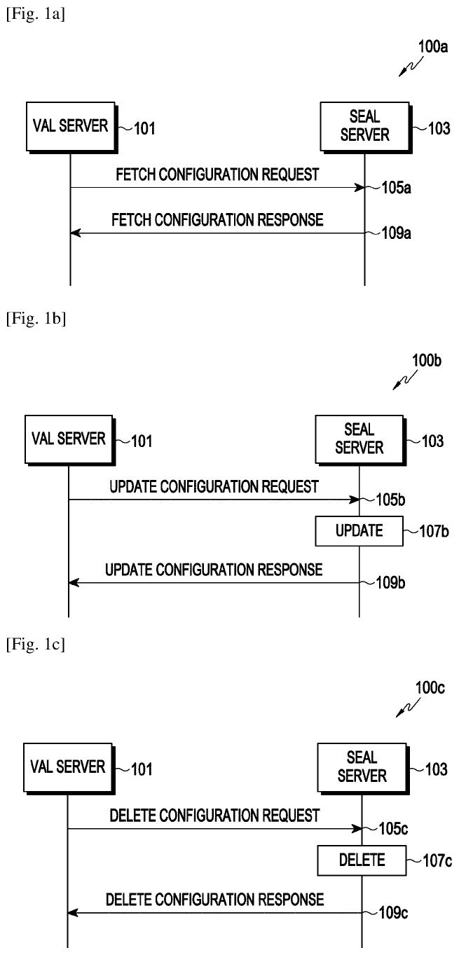

FIG. 1a is a representation of a sequence of events for fetching the VAL service-specific configuration information provisioned at the SEAL server.

FIG. 1b is a representation of a sequence of events for updating the VAL service-specific configuration information provisioned at the SEAL server.

FIG. 1c is a representation of a sequence of events for removing/deleting/de-pro visioning the VAL service-specific configuration information provisioned at the SEAL server.

This invention proposes to address the explained problem of updating the VAL service specific configuration information (VAL users information) at the SEAL Identity Management server.

### Solution 1: VAL Server Fetching the VAL Service Specific Configuration Information Provisioned at SEAL Server

FIG. 1a illustrates the procedure for a VAL server to fetch the VAL service specific configuration (VAL user information) information provisioned at the SEAL server.

In step 105a, the VAL server sends the Fetch Configuration request message to the SEAL server. This request message includes the query parameters, VAL server identity, VAL service identity (Identifier representing the VAL service at SEAL server) and VAL user IDs as shown in table 1.a.

TABLE 1.a
Fetch Configuration request

| Information element | Description |
|---|---|
| VAL server identity | The identity of the VAL server that |
| | provisioned the configuration information. |
| VAL service ID | Identify of the VAL service for which the |
| | configuration information is requested. |
| VAL user IDs | Identity list of VAL users for which the |
| | configuration information is requested (i.e. |
| | VAL User IDs or VAL UE IDs) |

In 109a, if the VAL server is authorized to fetch the VAL service specific configuration information matching the query parameters in Fetch Configuration request message (as in Table 1.a), then the SEAL returns the return the VAL service configurations matching the query parameters, in the Fetch Configuration response message as shown in table 1.b.

TABLE 1.b
Fetch Configuration response

| Information element | Description |
|---|---|
| VAL server identity | The identity of the VAL server that |
| | provisioned the VAL services |
| | configuration information. |
| VAL service-specific | Provides the list of VAL service specific |
| information which includes | configuration information provisioned at |
| the below information | SEAL server |
| elements. | |
| >VAL service ID | Identify of the VAL service for which the |
| | configuration information is provided. |
| >VAL user IDs | Identity list of VAL users for the specific |
| | VAL service (i.e. VAL User IDs or VAL |
| | UE IDs) |
| >VAL service information | Information specific to the VAL service. |

### Solution 2: VAL Server Updating the VAL Service Specific Configuration Information Provisioned at SEAL Server

FIG. 1b illustrates the procedure for a VAL server to update the VAL service specific configuration (VAL user information) information provisioned at the SEAL server.

In step 105b, the VAL server sends the Update Configuration request message to the SEAL server. This request message includes VAL service specific configuration information to be updated for a set of VAL services, i.e. VAL service identity(s) (Identifier representing the VAL service at SEAL server) and their configuration information (VAL users information, VAL service specific information) as shown in table 2.a.

TABLE 2.a
Update Configuration request

| Information element | Description |
|---|---|
| VAL service specific | Provides the list of VAL service specific |
| configuration information | configuration information provisioned at |
| | SEAL server |
| >VAL service ID | Identity of the VAL service for which the |
| | configuration information is provided. |
| >VAL user IDs | Identity list of VAL users for the specific |
| | VAL service (i.e. VAL User IDs or VAL |
| | UE IDs) |
| >VAL service information | Information specific to the VAL service. |

In step 109b, if the VAL server is authorized to update the VAL service specific configuration information for the VAL services in the Update Configuration request message, then the SEAL server updates the VAL service specific configuration information as in the request message and returns the result of the operation to the VAL server.

### Solution 3: VAL Server Removing or De-Provisioning the VAL Service Specific Configuration Information Provisioned at the SEAL Server

FIG. 1c illustrates the procedure for a VAL server to de-provision/remove the VAL service specific configuration (VAL user information) information provisioned at the SEAL server.

In step 105c, the VAL server sends the Delete Configuration request message to the SEAL server. This request message includes the list of VAL service identity(s) (Identifier representing the VAL service at SEAL server) for which the configuration information provisioned at the SEAL server needs to be deleted/removed/de-provisioned. Table 3.a. shows the information elements in the request message.

TABLE 3.a
Delete Configuration request

| Information element | Description |
|---|---|
| VAL service IDs | List of Identities of the VAL service for |
| | which the configuration information is to |
| | be removed/deleted/de-provisioned. |

In step 109c, if the VAL server is authorized to delete/de-provision/remove the VAL service specific configuration information for the VAL services identified by their identifiers in the Delete Configuration request message, then the SEAL server de-provisions/removes/deletes the VAL service specific configuration information at the SEAL server and returns the result of the operation to the VAL server.

In an embodiment, in solution 3, the VAL server may include the VAL server identity in the Delete Configuration request message. In such a scenario, the SEAL server de-provisions/removes/deletes all the VAL service specific configuration information provisioned by the VAL server identified by the VAL server identity in the Delete Configuration request message.

In an embodiment, in the solutions 1, 2 and 3 above, the SEAL server is SEAL Identity Management server.

Throughout this document, the VAL users information refers to VAL user IDs i.e. VAL User IDs or VAL UE IDs.

FIG. 1a illustrates a sequence diagram for service parameter provisioning in accordance with some embodiments of the present disclosure.

With reference to FIG. 1a, the environment 100a comprises of a VAL server 101 and a SEAL server 103. In one embodiment, the VAL server 101 and the SEAL server 103 form a system. In another embodiment, only the SEAL server 103 is part of the system.

The operation for fetching a VAL service specific configuration information is explained with reference to FIG. 1a. The pre-condition to perform this procedure or operation is that the VAL service specific configuration information is already provisioned at the SEAL server 103. In one or more embodiments of the present disclosure, the term “VAL service specific configuration information” may also be referred to as “VAL service specific information” and may be interchangeably used.

Furthermore, the steps for performing this procedure are as follows:

At step 105a, the SEAL server 103 receives from the VAL server 101 a fetch configuration request for fetching a VAL service specific configuration information provisioned at the SEAL server 103. In an embodiment, the fetch configuration request comprises at least one of, a VAL server identity, a VAL service identifier (ID), and VAL user ID(s), which are query parameters.

At step 109a, the SEAL server 103 sends to the VAL server 101 a fetch configuration response. In other words, if the VAL server 101 is authorized to fetch the VAL service specific configuration information matching the query parameters in the fetch configuration request, then the SEAL server 103 returns the VAL service configurations matching the query parameters, in the fetch configuration response. In an embodiment, the fetch configuration response comprises at least one of, a VAL server identity, the VAL service specific configuration information, a VAL service identifier (ID), VAL user ID(s), and a VAL service information.

In an embodiment, the SEAL server 103 is defined to perform one of, a group management, a configuration management, a location management, an identity management, a key management, or a network resource management.

FIG. 1b illustrates a sequence diagram for service parameter provisioning in accordance with some embodiments of the present disclosure.

With reference to FIG. 1b, the environment 100a comprises of a VAL server 101 and a SEAL server 103. In one embodiment, the VAL server 101 and the SEAL server 103 form a system. In another embodiment, only the SEAL server 103 is part of the system.

The operation for updating a VAL service specific configuration information is explained with reference to FIG. 1b. The pre-condition to perform this procedure or operation is that the VAL service specific configuration information is already provisioned at the SEAL server 103.

Furthermore, the steps for performing this procedure are as follows:

At step 105b, the SEAL server 103 receives from the VAL server 101 an update configuration request for updating a VAL service specific configuration information provisioned at the SEAL server 103 for a set of VAL services. In an embodiment, the update configuration request comprises at least one of, the VAL service specific configuration information, a VAL service identifier (ID), VAL user ID(s), and a VAL service information to be updated for a set of VAL services.

At step 107b, the SEAL server 103 updates the VAL service specific configuration information as received in the update configuration request. In other words if the VAL server 101 is authorized to update the VAL service specific configuration information for the VAL services in the update configuration request message, then the SEAL server 103 updates the VAL service specific configuration information as requested in the update configuration request.

At step 109b, the SEAL server 103 sends to the VAL server 101 an update configuration response. In other words, the SEAL server 103 returns the result of the operation at step 107b to the VAL server 101.

In an embodiment, the SEAL server 103 is defined to perform one of, a group management, a configuration management, a location management, an identity management, a key management, or a network resource management.

FIG. 1c illustrates a sequence diagram for service parameter provisioning in accordance with some embodiments of the present disclosure.

With reference to FIG. 1c, the environment 100a comprises of a VAL server 101 and a SEAL server 103. In one embodiment, the VAL server 101 and the SEAL server 103 form a system. In another embodiment, only the SEAL server 103 is part of the system.

The operation for deleting a VAL service specific configuration information is explained with reference to FIG. 1c. The pre-condition to perform this procedure or operation is that the VAL service specific configuration information is already provisioned at the SEAL server 103.

Furthermore, the steps for performing this procedure are as follows:

At step 105c, the SEAL server 103 receives from the VAL server 101 a delete configuration request for deleting a VAL service specific configuration information provisioned at the SEAL server 103. In an embodiment, the delete configuration request comprises at least one of, VAL service Identifier (ID) (s) and VAL server identifier.

At step 107c, the SEAL server 103 deletes the VAL service specific configuration information as received in the delete configuration request. In other words, if the VAL server 101 is authorized to delete/remove/de-provision the VAL service specific configuration information for the VAL services identified by their identifiers in the delete configuration request, then the SEAL server 103 deletes the VAL service specific configuration information as requested in the delete configuration request.

At step 109c, the SEAL server 103 sends to the VAL server 101 a delete configuration response. In other words, the SEAL server 103 returns the result of the operation at step 107c to the VAL server 101.

In an embodiment, the SEAL server 103 is defined to perform one of, a group management, a configuration management, a location management, an identity management, a key management, or a network resource management.

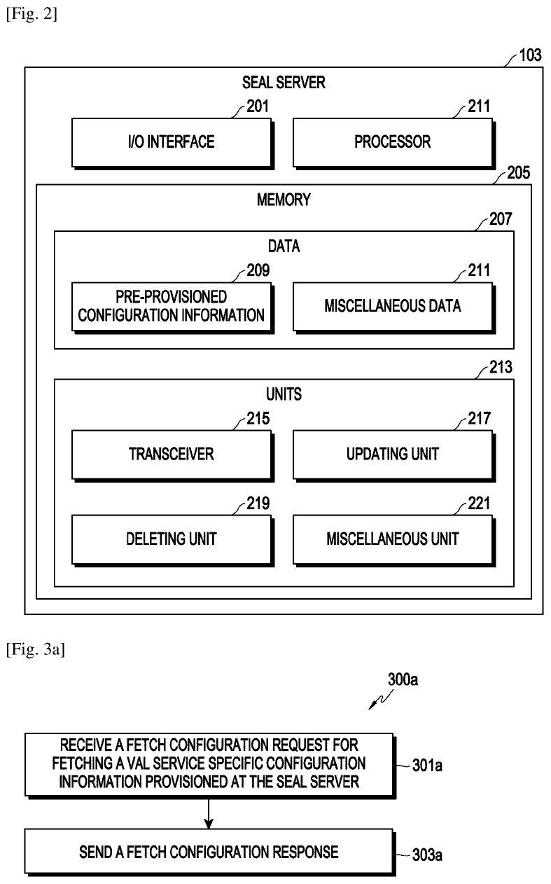

FIG. 2 shows a detailed block diagram of the SEAL server 103 in accordance with some embodiments of the present disclosure.

The SEAL server 103 for service parameter provisioning includes an Input-Output (I/O) interface 201, a processor 203, and a memory 205. In the present embodiment, data 207 is stored within the memory 205.

The I/O interface 201 is configured to receive a request associated with the VAL service specific configuration information and to transmit a response associated with the VAL service specific configuration information. The request comprises one of a fetch configuration request, an update configuration request or a delete configuration request. The response comprises one of a fetch configuration response, an update configuration response or a delete configuration response. The I/O interface 201 employs communication protocols or methods such as, without limitation, audio, analog, digital, monoaural, Radio Corporation of America (RCA) connector, stereo, IEEE®-1394 high speed serial bus, serial bus, Universal Serial Bus (USB), infrared, Personal System/2 (PS/2) port, Bayonet Neill-Concelman (BNC) connector, coaxial, component, composite, Digital Visual Interface (DVI), High-Definition Multimedia Interface (HDMI®), Radio Frequency (RF) antennas, S-Video, Video Graphics Array (VGA), IEEE® 802.11b/g/n/x, Bluetooth, cellular e.g., Code-Division Multiple Access (CDMA), High-Speed Packet Access (HSPA+), Global System for Mobile communications (GSM®), Long-Term Evolution (LTE®), Worldwide interoperability for Microwave access (WiMax®), or the like.

The memory 205 is communicatively coupled to the processor 203 of the SEAL server 103. The memory 205, also, stores processor-executable instructions which cause the processor 203 to execute the instructions for managing VAL service specific configuration information. Managing VAL service specific configuration information is one of fetching VAL service specific configuration information, updating VAL service specific configuration information or deleting VAL service specific configuration information. The memory 205 includes, without limitation, memory drives, removable disc drives, etc. The memory drives may further include a drum, magnetic disc drive, magneto-optical drive, optical drive, Redundant Array of Independent Discs (RAID), solid-state memory devices, solid-state drives, etc.

The processor 203 includes at least one data processor for managing VAL service specific configuration information. The processor 203 may include specialized processing units such as integrated system (bus) controllers, memory management control units, floating point units, graphics processing units, digital signal processing units, etc.

The data 207 include, for example, pre-provisioned configuration information 209, and miscellaneous data 211.

Pre-provisioned configuration information 209: The pre-provisioned configuration information 209 includes VAL service Identifier (ID) (s), corresponding VAL users (VAL User IDs) for each of the VAL services.

Miscellaneous data 211: The miscellaneous data 211 stores data, including meta data, and temporary files, generated by the units of the SEAL server 103 for performing the various functions of the SEAL server 103.

In the embodiment of the present disclosure, the data 207 in the memory 205 are processed by the one or more units 213 (also, referred as units) of the SEAL server 103. In the embodiment, the one or more units 213 are implemented as dedicated hardware units (e.g., circuits). As used herein, the term unit refers to, for example, an Application Specific Integrated Circuit (ASIC), an electronic circuit, a Programmable System-on-Chip (PSoC), a combinational logic circuit, and/or other suitable components that provide the described functionality. In one embodiment of the present disclosure, the one or more units 213 are communicatively coupled to the processor 203 for managing VAL service specific configuration information. The one or more units 213 when configured with the functionality defined in the present disclosure results in a novel hardware.

In one implementation, the one or more units 213 include, but are not limited to, a transceiver 215, an updating unit 217, and a deleting unit 219. The one or more units 213, also, includes miscellaneous units 221 to perform various miscellaneous functionalities of the SEAL server 103.

Transceiver 215: The transceiver 215 receives from the VAL server 101 a fetch configuration request for fetching a VAL service specific configuration information provisioned at the SEAL server 103. In an embodiment, the fetch configuration request comprises at least one of, a VAL server identity, a VAL service identifier (ID), and VAL user ID(s), which are query parameters. The transceiver 215 sends to the VAL server 101 a fetch configuration response. In other words, if the VAL server 101 is authorized to fetch the VAL service specific configuration information matching the query parameters in the fetch configuration request, then the transceiver 215 returns the VAL service configurations matching the query parameters, in the fetch configuration response. In an embodiment, the fetch configuration response comprises at least one of, a VAL server identity, the VAL service specific configuration information, a VAL service identifier (ID), VAL user ID(s), and a VAL service information.

The transceiver 215 receives from the VAL server 101 an update configuration request for updating a VAL service specific configuration information provisioned at the SEAL server 103 for a set of VAL services. In an embodiment, the update configuration request comprises at least one of, the VAL service specific configuration information, a VAL service identifier (ID), VAL user ID(s), and a VAL service information to be updated for a set of VAL services. Subsequently, the transceiver 215 sends to the VAL server 101, an update configuration response. In other words, the SEAL server 103 returns the result of the updating unit 217 to the VAL server 101.

The transceiver 215 receives from the VAL server 101 a delete configuration request for deleting a VAL service specific configuration information provisioned at the SEAL server 103. In an embodiment, the delete configuration request comprises at least one of, VAL service Identifier (ID) (s) and VAL server identifier. Subsequently, the transceiver 215 sends to the VAL server 101 a delete configuration response. In other words, the transceiver 215 returns the result of the operation by the deleting unit 217 to the VAL server 101.

Updating unit 217: The updating unit 217 updates the VAL service specific configuration information as received in the update configuration request. In other words if the VAL server 101 is authorized to update the VAL service specific configuration information for the VAL services in the update configuration request message, then the updating unit 217 updates the VAL service specific configuration information as requested in the update configuration request.

Deleting unit 219: The deleting unit 219 deletes the VAL service specific configuration information as received in the delete configuration request. In other words, if the VAL server 101 is authorized to delete/remove/de-provision the VAL service specific configuration information for the VAL services identified by their identifiers in the delete configuration request, then the deleting unit 219 deletes the VAL service specific configuration information as requested in the delete configuration request.

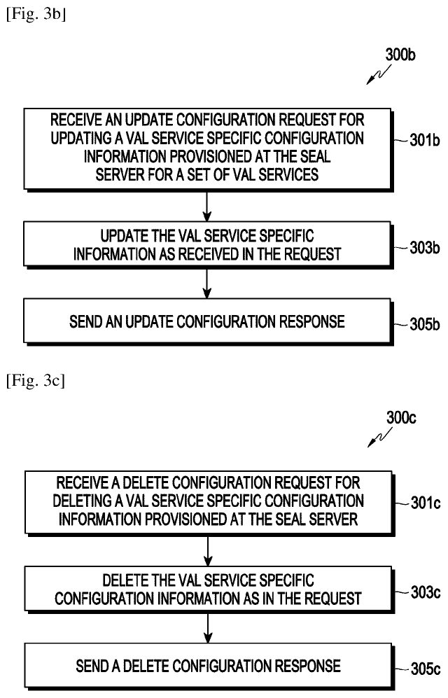

FIG. 3a illustrates a flowchart showing a method for service parameter provisioning in accordance with some embodiments of the present disclosure.

As illustrated in FIG. 3a, the method 300a includes one or more operation steps for service parameter provisioning in accordance with some embodiments of the present disclosure. The method 300a may be described in the general context of computer executable instructions. Generally, computer executable instructions can include routines, programs, objects, components, data structures, procedures, modules, and functions, which perform particular functions or implement particular abstract data types.

The order in which the method 300a is described is not intended to be construed as a limitation, and any number of the described method operation steps can be combined in any order to implement the method. Additionally, individual operation steps may be deleted from the methods without departing from the scope of the subject matter described herein. Furthermore, the method can be implemented in any suitable hardware, software, firmware, or combination thereof.

At operation step 301a, the processor 203 of the SEAL server 103 receives from the VAL server 101 a fetch configuration request for fetching a VAL service specific configuration information provisioned at the SEAL server 103. In an embodiment, the fetch configuration request comprises at least one of, a VAL server identity, a VAL service identifier (ID), and VAL user ID(s), which are query parameters.

At operation step 303a, the processor 203 of the SEAL server 103 sends to the VAL server 101 a fetch configuration response. In other words, if the VAL server 101 is authorized to fetch the VAL service specific configuration information matching the query parameters in the fetch configuration request, then the processor 203 of the SEAL server 103 returns the VAL service configurations matching the query parameters, in the fetch configuration response. In an embodiment, the fetch configuration response comprises at least one of, a VAL server identity, the VAL service specific configuration information, a VAL service identifier (ID), VAL user ID(s), and a VAL service information.

In an embodiment, the processor 203 of the SEAL server 103 is defined to perform one of, a group management, a configuration management, a location management, an identity management, a key management, or a network resource management.

FIG. 3b illustrates a flowchart showing a method for service parameter provisioning in accordance with some embodiments of the present disclosure.

As illustrated in FIG. 3b, the method 300b includes one or more operation steps for service parameter provisioning in accordance with some embodiments of the present disclosure. The method 300b may be described in the general context of computer executable instructions. Generally, computer executable instructions can include routines, programs, objects, components, data structures, procedures, modules, and functions, which perform particular functions or implement particular abstract data types.

The order in which the method 300b is described is not intended to be construed as a limitation, and any number of the described method operation steps can be combined in any order to implement the method. Additionally, individual operation steps may be deleted from the methods without departing from the scope of the subject matter described herein. Furthermore, the method can be implemented in any suitable hardware, software, firmware, or combination thereof.

At operation step 301b, the processor 203 of the SEAL server 103 receives from the VAL server 101 an update configuration request for updating a VAL service specific configuration information provisioned at the SEAL server 103 for a set of VAL services. In an embodiment, the update configuration request comprises at least one of, the VAL service specific configuration information, a VAL service identifier (ID), VAL user ID(s), and a VAL service information to be updated for a set of VAL services.

At operation step 303b, the processor 203 of the SEAL server 103 updates the VAL service specific configuration information as received in the update configuration request. In other words if the VAL server 101 is authorized to update the VAL service specific configuration information for the VAL services in the update configuration request message, then, the processor 203 of the SEAL server 103 updates the VAL service specific configuration information as requested in the update configuration request.

At operation step 305b, the processor 203 of the SEAL server 103 sends to the VAL server 101 an update configuration response. In other words, the processor 203 of the SEAL server 103 returns the result of the operation at operation step 303b to the VAL server 101.

In an embodiment, the processor 203 of the SEAL server 103 is defined to perform one of, a group management, a configuration management, a location management, an identity management, a key management, or a network resource management.

FIG. 3c illustrates a flowchart showing a method for service parameter provisioning in accordance with some embodiments of the present disclosure.

As illustrated in FIG. 3c, the method 300c includes one or more operation steps for service parameter provisioning in accordance with some embodiments of the present disclosure. The method 300c may be described in the general context of computer executable instructions. Generally, computer executable instructions can include routines, programs, objects, components, data structures, procedures, modules, and functions, which perform particular functions or implement particular abstract data types.

The order in which the method 300c is described is not intended to be construed as a limitation, and any number of the described method operation steps can be combined in any order to implement the method. Additionally, individual operation steps may be deleted from the methods without departing from the scope of the subject matter described herein. Furthermore, the method can be implemented in any suitable hardware, software, firmware, or combination thereof.

At operation step 301c, the processor 203 of the SEAL server 103 receives from the VAL server 101 a delete configuration request for deleting a VAL service specific configuration information provisioned at the SEAL server 103. In an embodiment, the delete configuration request comprises at least one of, VAL service Identifier (ID) (s) and VAL server identifier.

At operation step 303c, the processor 203 of the SEAL server 103 deletes the VAL service specific configuration information as received in the delete configuration request. In other words if the VAL server 101 is authorized to delete/remove/de-provision the VAL service specific configuration information for the VAL services identified by their identifiers in the delete configuration request, then the processor 203 of the SEAL server 103 deletes the VAL service specific configuration information as requested in the delete configuration request.

At operation step 305c, the processor 203 of the SEAL server 103 sends to the VAL server 101 a delete configuration response. In other words, the processor 203 of the SEAL server 103 returns the result of the operation step 303c to the VAL server 101.

In an embodiment, the processor 203 of the SEAL server 103 is defined to perform one of, a group management, a configuration management, a location management, an identity management, a key management, or a network resource management.

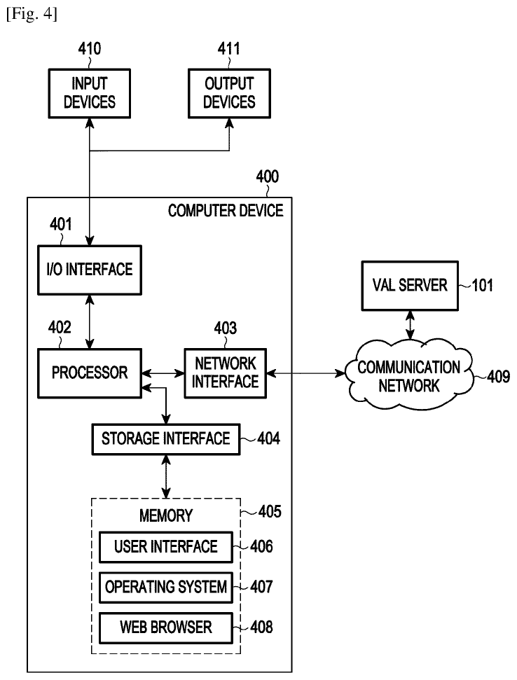

In some embodiments, FIG. 4 illustrates a block diagram of an exemplary computer system 400 for implementing embodiments consistent with the present disclosure.

In some embodiments, the computer system 400 can be a SEAL server 103 that comprises a processor (also referred as a processor 402 in this FIG. 4) that is used for service parameter provisioning. The processor 402 may include at least one data processor for executing program components for executing user or system-generated business processes. The processor 402 may include specialized processing units such as integrated system (bus) controllers, memory management control units, floating point units, graphics processing units, digital signal processing units, etc.

The processor 402 may be disposed in communication with input devices 410 and output devices 411 via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), High-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, computer system 400 may communicate with input devices 410 and output devices 411.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with a VAL server 101.

The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

Further, the communication network 409 may include a variety of network devices, including routers, bridges, servers, computing devices, storage devices, etc. In some embodiments, the processor 402 may be disposed in communication with a memory 405 (e.g., Random Access Memory (RAM), ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, a user interface 406, an operating system 407, a web browser 408 etc. In some embodiments, the computer system 400 may store user/application data, such as the data, variables, records, etc. as described in this invention. Such databases may be implemented as fault-tolerant, relational, scalable, secure databases such as Oracle or Sybase.

Operating system 407 may facilitate resource management and operation of computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like. User interface 406 may facilitate display, execution, interaction, manipulation, or operation of program components through textual or graphical facilities. For example, user interfaces may provide computer interaction interface elements on a display system operatively connected to computer system 400, such as cursors, icons, check boxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

The computer system 400 may implement web browser 408 stored program components. Web browser 408 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, ADOBE® FLASH®, JAVASCRIPT®, JAVA®, Application Programming Interfaces (APIs), etc. The computer system 400 may implement a mail server stored program component. The mail server may be an Internet mail server such as Microsoft Exchange, or the like. The mail server may utilize facilities such as ASP, ACTIVEX®, ANSI® C++/C #, MICROSOFT®, NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL, MICROSOFT® ENTOURAGE®, MICROSOFT® OUTLOOK″, MOZILLA® THUNDERBIRD®, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD), Read-Only Memory (ROMs), Digital Video Disc (DVDs), flash drives, disks, and any other known physical storage media.

Some of the advantages of the present disclosure are listed below.

In existing systems, the VAL server can only provision the configuration information (VAL service specific information such as VAL user IDs) to the SEAL server. This inhibits various VAL servers from same VAL service provider to fetch, update or delete the VAL service specific information at the SEAL. This leads to the presence of dangling information at the SEAL server, as the VAL server has to create new configuration information each time. This also causes management overhead at the SEAL server as it has to store and manage lots of irrelevant information. The method described in the present disclosure overcomes the above-mentioned problems by providing new services for fetching, updating and deleting VAL service specific information. This enables better management of VAL service specific information at both VAL service provider and the SEAL provider. This also enables efficient management of VAL service specific information.

The present disclosure enables better and flexible management of VAL user authentication information for Industry vertical applications which leads to better adoption of 3GPP Fifth Generation (5G) systems by industry vertical applications.

In the present disclosure, management of VAL user authentication information in interoperable manner by multiple VAL servers from the same VAL service provider leads to better adoption/implementation of these services.

Some of the clauses are mentioned below.

[1]: A method for service parameter provisioning, comprising: receiving, by a Service Enabler Architecture Layer (SEAL) server from a Vertical Application Layer (VAL) server, a fetch configuration request for fetching a VAL service specific configuration information provisioned at the SEAL server; and sending, by the SEAL server, a fetch configuration response.

[2]: The method as described in [1], wherein the fetch configuration request comprises at least one of, a VAL server identity, a VAL service identifier (ID), and VAL user ID(s).

[3]: The method as described in [1], wherein the fetch configuration response comprises at least one of, a VAL server identity, the VAL service specific configuration information, a VAL service identifier (ID), VAL user ID(s), and a VAL service information.

[4]: The method as described in [1], wherein the SEAL server is defined to perform one of, a group management, a configuration management, a location management, an identity management, a key management, or a network resource management.

[5]: A Service Enabler Architecture Layer (SEAL) server for service parameter provisioning, comprising: a processor; and a memory, wherein the memory stores processor-executable instructions, which, on execution, cause the processor to: receive from a Vertical Application Layer (VAL) server, a fetch configuration request for fetching a VAL service specific configuration information provisioned at the SEAL server; and send a fetch configuration response.

[6]: The SEAL server as described in [5], wherein the fetch configuration request comprises at least one of, a VAL server identity, a VAL service identifier (ID), and VAL user ID(s).

[7]: The SEAL server as described in [5], wherein the fetch configuration response comprises at least one of, a VAL server identity, a VAL service-specific information, a VAL service identifier (ID), VAL user ID(s), and a VAL service information.

[8]: The SEAL server as described in [5], wherein the SEAL server is defined to perform one of, a group management, a configuration management, a location management, an identity management, a key management, or a network resource management.

[9]: A method for service parameter provisioning, comprising: receiving, by a Service Enabler Architecture Layer (SEAL) server from a Vertical Application Layer (VAL) server, an update configuration request for updating a VAL service specific configuration information provisioned at the SEAL server for a set of VAL services; updating, by the SEAL server, the VAL service specific configuration information as received in the update configuration request; and sending, by the SEAL server, an update configuration response.

[10]: The method as described in [9], wherein the update configuration request comprises at least one of, the VAL service specific configuration information, a VAL service identifier (ID), VAL user ID(s), and a VAL service information.

[11]: The method as described in [9], wherein the SEAL server is defined to perform one of, a group management, a configuration management, a location management, an identity management, a key management or a network resource management.

[12]: A Service Enabler Architecture Layer (SEAL) server for service parameter provisioning, comprising: a processor; and a memory, wherein the memory stores processor-executable instructions, which, on execution, cause the processor to: receive from a Vertical Application Layer (VAL) server, an update configuration request for updating a VAL service specific configuration information provisioned at the SEAL server for a set of VAL services; update the VAL service specific configuration information at the SEAL server, as received in the update configuration request; and send an update configuration response.

[13]: The SEAL server as described in [12], wherein the update configuration request comprises at least one of, the VAL service specific configuration information, a VAL service identifier (ID), VAL user ID(s), and a VAL service information.

[14]: The SEAL server as described in [12], wherein the SEAL server is defined to perform one of, a group management, a configuration management, a location management, an identity management, a key management or a network resource management.

[15]: A method for service parameter provisioning, comprising: receiving, by a Service Enabler Architecture Layer (SEAL) server from a Vertical Application Layer (VAL) server, a delete configuration request for deleting a VAL service specific configuration information provisioned at the SEAL server; deleting, by the SEAL server, the VAL service specific configuration information as in the delete configuration request; and sending, by the SEAL server, a delete configuration response.

[16]: The method as described in [15], wherein the delete configuration request comprises at least one of, VAL service Identifier (ID) (s) and VAL server identifier.

[17]: The method as described in [15], wherein the SEAL server is defined to perform one of, a group management, a configuration management, a location management, an identity management, a key management or a network resource management.

[18]: A Service Enabler Architecture Layer (SEAL) server for service parameter provisioning, comprising: a processor; and a memory, wherein the memory stores processor-executable instructions, which, on execution, cause the processor to: receive from a Vertical Application Layer (VAL) server, a delete configuration request for deleting a VAL service specific configuration information provisioned at the SEAL server; delete the VAL service specific configuration information as in the delete configuration request; and send a delete configuration response.

[19]: The SEAL server as described in [18], wherein the delete configuration request comprises at least one VAL service Identifier (ID) (s) and VAL server identifier.

[20]: The SEAL server as described in [18], wherein the SEAL server is defined to perform one of, a group management, a configuration management, a location management, an identity management, a key management or a network resource management.

With respect to the use of substantially any plural and singular terms herein, those having skill in the art can translate from the plural to the singular and from the singular to the plural as is appropriate to the context or application. The various singular or plural permutations may be expressly set forth herein for sake of clarity.

One or more computer-readable storage media may be utilized in implementing embodiments consistent with the present disclosure. A computer-readable storage medium refers to any type of physical memory on which a software (program) readable by an information processing apparatus may be stored. The information processing apparatus includes a processor and a memory, and the processor executes a process of the software. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, volatile memory, non-volatile memory, hard drives, CD ROMs, DVDs, flash drives, disks, and any other known physical storage media.

The described operations may be implemented as a method, a system, or an article of manufacture using at least one of standard programming and engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD ROMs, DVDs, optical disks, etc.), volatile and non-volatile memory devices (e.g., Programmable ROM (PROMs), Electrically Erasable PROM (EEPROMs), ROMs, RAMs, Dynamic RAM (DRAMs), Static RAM (SRAMs), Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), ASIC, etc.).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device or article (whether or not they cooperate) may be used in place of a single device or article. Similarly, where more than one device or article is described herein (whether or not they cooperate), it will be readily apparent that a single device or article may be used in place of the more than one device, or article, or a different number of devices or articles may be used instead of the shown number of devices or programs. At least one of the functionalities and the features of a device may be alternatively embodied by one or more other devices which are not explicitly described as having such functionality or features. Thus, other embodiments of the invention need not include the device itself.

The illustrated operations of FIGS. 3a, 3b and 3c show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

REFERRAL NUMERALS:

| Reference | |
|---|---|
| number | Description |
| 101 | VAL server |
| 103 | SEAL server |
| 201 | I/O Interface |
| 203 | Processor |
| 205 | Memory |
| 207 | Data |
| 209 | Pre-Provisioned Configuration Information |
| 211 | Miscellaneous Data |
| 213 | Units |
| 215 | Transceiver Unit |
| 217 | Updating Unit |
| 219 | Deleting Unit |
| 221 | Miscellaneous Unit |
| 400 | Computing Device |
| 401 | I/O Interface |
| 402 | Processor |
| 403 | Network Interface |
| 404 | Storage Interface |
| 405 | Memory |
| 406 | User Interface |
| 407 | Operating System |
| 408 | Web Browser |
| 409 | Communication Network |
| 410 | Input Devices |
| 411 | Output Devices |

1. A method (300a) performed by a service enabler architecture layer (SEAL) server (103), the method (300a) comprising:
receiving (301a), from a vertical application layer (VAL) server (101), a fetch configuration request for fetching VAL service specific configuration information provisioned at the SEAL server (103); and
sending (303a) a fetch configuration response in response to the fetch configuration request.

2. The method (300a) of claim 1, wherein the fetch configuration request comprises at least one of a VAL server (101) identity, a VAL service identifier (ID), or at least one VAL user ID.

3. The method (300a) of claim 1, wherein the fetch configuration response comprises at least one of a VAL server (101) identity, the VAL service specific configuration information, a VAL service identifier (ID), at least one VAL user ID, or VAL service information.

4. The method (300a) of claim 1, wherein the SEAL server (103) is configured to perform at least one of a group management, a configuration management, a location management, an identity management, a key management, or a network resource management.

5. A method (300b) performed by a service enabler architecture layer (SEAL) server (103), the method (300b) comprising:
receiving (301b), from a vertical application layer (VAL) server (101), an update configuration request for updating (303b) a VAL service specific configuration information provisioned at the SEAL server (103) for a set of VAL services;
updating (303b) the VAL service specific configuration information as received in the update configuration request; and
sending (305b) an update configuration response in response to the update configuration request.

6. The method (300b) of claim 5, wherein the update configuration request comprises at least one of the VAL service specific configuration information, a VAL service identifier (ID), at least one VAL user ID, or VAL service information.

7. The method (300b) of claim 5, wherein the SEAL server (103) is configured to perform one of a group management, a configuration management, a location management, an identity management, a key management, or a network resource management.

8. A method (300c) performed by a service enabler architecture layer (SEAL) server (103), the method (300c) comprising:
receiving (301c), from a Vertical Application Layer (VAL) server (101), a delete configuration request for deleting VAL service specific configuration information provisioned at the SEAL server (103);
deleting (303c) the VAL service specific configuration information as in the delete configuration request; and
sending (305c) a delete configuration response in response to the delete configuration request.

9. The method (300c) of claim 8, wherein the delete configuration request comprises at least one of at least one VAL service Identifier (ID) and a VAL server (101) identifier.

10. The method (300c) of claim 8, wherein the SEAL server (103) is configured to perform one of a group management, a configuration management, a location management, an identity management, a key management, or a network resource management.

11. A service enabler architecture layer (SEAL) server (103), comprising:
a transceiver (215); and
a processor (203) connected to the transceiver (215) and configured to:
receive, from a vertical application layer (VAL) server (101) via the transceiver (215), a fetch configuration request for fetching VAL service specific configuration information provisioned at the SEAL server (103), and
send a fetch configuration response in response to the fetch configuration request.

12. The SEAL server (103) of claim 11, wherein the fetch configuration request comprises at least one of, a VAL server (101) identity, a VAL service identifier (ID), or at least one VAL user ID(s).

13. The SEAL server (103) of claim 11, wherein the fetch configuration response comprises at least one of a VAL server (101) identity, a VAL service-specific information, a VAL service identifier (ID), at least one VAL user ID, or VAL service information.

14. The SEAL server (103) of claim 11, wherein the SEAL server (103) is configured to perform one of, a group management, a configuration management, a location management, an identity management, a key management, or a network resource management.

15. A service enabler architecture layer (SEAL) server (103), comprising:
a transceiver (215); and
a processor (203) connected to the transceiver (215) and configured to:
receive (301b), from a vertical application layer (VAL) server (101), an update configuration request for updating (303b) a VAL service specific configuration information provisioned at the SEAL server (103) for a set of VAL services;
update (303b) the VAL service specific configuration information as received in the update configuration request; and
send (305b) an update configuration response in response to the update configuration request.
